(19) United States
(12) Patent Application Publication
(10) Pub. No.: US 2010/0151791 A1
(43) Pub. Date: Jun. 17, 2010

(54) AUDIO DATA SERVICE PROVISION METHOD AND SYSTEM

(75) Inventors: Hong Soo YI, Gyeonggi-do (KR); Hyong Yol CHU, Gyeonggi-do (KR)

Correspondence Address: CHA & REITER, LLC, 210 ROUTE 4 EAST STE 103, PARAMUS, NJ, 07652, US

(73) Assignee: Samsung Electronics Co., LTD., Gyeonggi-Do (KR)

(21) Appl. No.: 12/636,893

(22) Filed: Dec. 14, 2009

(30) Foreign Application Priority Data
Dec. 15, 2008 (KR) 10-2008-0126966

(51) Int. Cl. H04B 7/005

(52) U.S. Cl. 455/41.3

(57) ABSTRACT

An audio data service provision method and system for efficiently switching the audio data service among multiple Bluetooth devices. An audio data service provision method of the present invention includes establishing a first audio data channel between a first and a second Bluetooth devices for providing an audio data service; receiving, at the first Bluetooth device, an audio data channel assignment request from a third Bluetooth device; and releasing, when the audio data channel assignment request is accepted, the first audio data channel and establishing a second audio data channel with the third Bluetooth device for providing the audio data service.

### CLAIM OF PRIORITY

This application claims the benefit of priority from an application entitled “AUDIO DATA SERVICE PROVISION METHOD AND SYSTEM” filed in the Korean Intellectual Property Office on Dec. 15, 2008 and assigned Serial No. 10-2008-0126966, the contents of which are incorporated herein by reference in its entirety.

### BACKGROUND OF THE INVENTION

1. Field of the Invention

The present invention relates to Bluetooth communications. More particularly, the present invention relates to an audio data service provision method and system for efficiently switching the audio data service among multiple Bluetooth devices in a piconet.

2. Description of the Related Art

Bluetooth is a radio communication standard for short distance radio communication protocol using the Industrial Scientific Medical (ISM) band of 2.4 GHz band. When other Bluetooth devices exist around a certain area, a host device discovers the Bluetooth devices by using Host Controller Interface (HCI) query and acquires information on the services supported by the respective Bluetooth devices, i.e. the Bluetooth profiles, from the HCI responses.

A Bluetooth profile is a specification for describing standard capabilities of applications with the arrangement of protocols and a set of commands configured to operate a Bluetooth device according to the services supported by the Bluetooth device. There are multiple Bluetooth profiles to support various applications operating with the Bluetooth devices. Among them, a handsfree profile (HFP) is one of most commonly used profiles. The Bluetooth devices supporting the HFP can be classified into handsfree (HF) devices and Audio Gateway (AG) devices. The HFP includes a Headset Profile (HSP). The HF devices typically include mono and stereo headsets and handsfree modules, and the AG devices include cellular phones and personal computers. The HF and AG devices establish a Service Link Connection (SLC) for Bluetooth communication with each other.

In the meantime, the Bluetooth technology supports both a delay sensitive traffic, such as voice and audio, and a high speed bursty traffic, such as packet data. For these purposes, Bluetooth specifies two types of communication links: Synchronous Connection Oriented (SCO) link for the delay sensitive voice and audio and Asynchronous Connectionless (ACL) link for the bursty packet data. The term “SCO link” is interchangeably used with “audio data channel”, hereinafter. Bluetooth supports 3 SCO channels and 7 ACL channels between a master device which requests for Bluetooth communications and a group of slave devices. However, in order for the master device to be connected to a slave device through an SLC link, the master device must break the SLC link before establishing an SLC link with another slave device. This required link breakage means that while an HF device can connect a service to multiple AGs selectively, the HF cannot maintain multiple SCO links simultaneously. Also, the AG device can connect a service to multiple AGs selectively but cannot maintain multiple SCO links simultaneously. There is, therefore, a need for a method to establish multiple SCO and ACL links between an AG (or HF) device and multiple HF (AG) devices simultaneously for improving Bluetooth communication efficiency.

### SUMMARY OF THE INVENTION

The present invention provides an audio data service provision method and system that switches the audio data service among multiple slave devices connected to a master device in a network such as Bluetooth.

In accordance with an exemplary embodiment of the present invention, an audio data service provision method preferably includes establishing a first audio data channel between a first and a second Bluetooth devices for providing an audio data service; receiving, at the first Bluetooth device, an audio data channel assignment request from a third Bluetooth device; and releasing, when the audio data channel assignment request is accepted, the first audio data channel and establishing a second audio data channel with the third Bluetooth device for providing the audio data service.

In accordance with another exemplary embodiment of the present invention, an audio data service provision method preferably includes a first Bluetooth device assigning audio data channels and packet data channels individually to second, third, and fourth Bluetooth devices; opening an audio path to the second Bluetooth device for an audio data service; receiving an audio path request from the third Bluetooth device; and closing, when the audio path request is accepted, the audio path to the second Bluetooth device and opening the audio path to the third Bluetooth device.

In accordance with still another exemplary embodiment of the present invention, an audio data service provision system includes a master Bluetooth device which performs an audio data service with a device connected through an opened audio data channel, and means for verifying the audio data channel assignment request and controls assignment of the audio data channel, when an audio data channel assignment request is received from a device; and at least one slave Bluetooth device which sends the audio data channel assignment request to the master Bluetooth device, when audio data to be transmitted to the master Bluetooth device is generated.

The described features, advantages, and characteristics of the invention may be combined in any suitable manner in one or more exemplary embodiments. One skilled in the relevant art will recognize that the invention may be practiced without one or more of the specific features or advantages of a particular exemplary embodiment. In other instances, additional features and advantages may be recognized in certain exemplary embodiments that may not be present in all exemplary embodiments of the invention.

### BRIEF DESCRIPTION OF THE DRAWINGS

The above features and advantages of the present invention will be more apparent from the following detailed description in conjunction with the accompanying drawings, in which:

FIG. 1 is a diagram illustrating a conventional Bluetooth protocol stack;

FIG. 2 is a diagram illustrating a multi-device audio connection system according to an exemplary embodiment of the present invention;

FIGS. 3A and 3B are diagrams illustrating an audio connection switching procedure in a multi-device audio connection system of FIG. 2;

FIG. 4 is a flowchart illustrating exemplary operation of an audio data service provision method according to an exemplary embodiment of the present invention;

FIG. 5 is a diagram illustrating a multi-device audio connection system according to another exemplary embodiment of the present invention; and

FIGS. 6A and 6B are diagrams illustrating an audio connection switching procedure in the multi-device audio connection system of FIG. 5.

### DETAILED DESCRIPTION

Exemplary embodiments of the present invention are described herein with reference to the accompanying drawings in detail. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

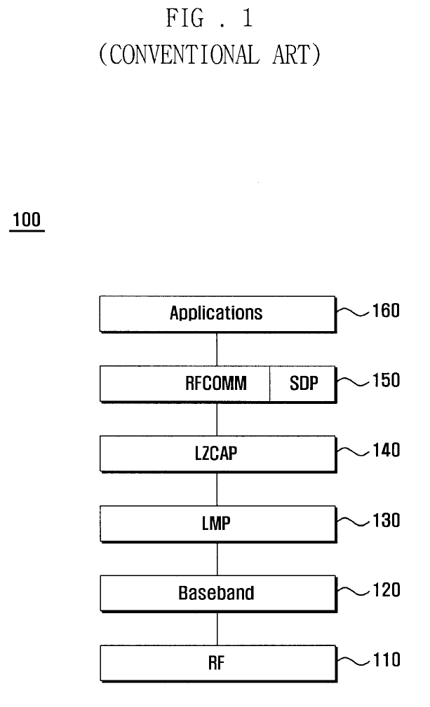

FIG. 1 is a diagram illustrating a Bluetooth protocol stack according to the conventional art. While the Bluetooth protocol stack shown FIG. 1 is directed to a master device, the diagram is applicable to slave devices.

Although the audio data service provision method and system according to the present invention is directed to the audio channel connection/disconnection procedure among the Bluetooth devices supporting the headset profile such as handsfree device, headset, and a Bluetooth-enabled mobile terminal in the following description. However, the present invention is not limited thereto. For instance, the audio data service provision method and system can be applied to the audio connection/disconnection procedure among the Bluetooth devices supporting other audio-related profiles. The headset profile defines the requirements for audio connections between an Audio Gateway (AG) device and a headset device and features and procedures to secure interoperability among the Bluetooth headsets.

Referring now to FIG. 1, the Radio Frequency (RF) layer 110 is the lowest layer defining the characteristics of the radio interface. The RF layer 110 uses Frequency Hopping to spread the energy across the ISM spectrum in 79 hops displaced by 1 MHz between 2.4 and 2.4835 GHz at 1600 hops per second, Gaussian Frequency Shift Keying (G-FSK) modulation scheme, Time Division Duplex (TDD) to transmit and receive digitally modulated packet data and audio data.

Still referring to FIG. 1, the Baseband layer 120 is responsible for establishment of physical links between master and slave devices, error correction, logical channel management, frequency hopping algorithm(s), and security. There are two different types of physical links: a Synchronous Connection-Oriented (SCO) link, which does not guarantee transmission reliability, and Asynchronous Connection-Less (ACL) link, which guarantees transmission reliability. Whether to guarantee the transmission reliability depends upon the data retransmission function. A piconet is a group of Bluetooth devices that share a common frequency hopping pattern. The piconet can be composed of up to 7 Bluetooth devices. Within the piconet, one device performs a management functions such as generation of the frequency hopping pattern and is known as the master device. All other devices are referred to as slave devices. The SCO link provides a circuit-switched connection, while the ACL link acts like a packet-switched connection. The packets are transmitted on different hopping frequencies. A packet spans on time slot in general, but a data packet can be 1, 3, or 5 time slots long. The voice packets can be transmitted at 64 kbps using on symmetric channel, and the data packets can be transmitted at the data rate of up to 723.2/57.6 kbps on asymmetric channel or 432.6 kbps on symmetric channel.

With continued reference to FIG. 1, the Link Manager Protocol (LMP) layer 130 is a data link protocol layer which is responsible for link setup, Automatic Repeat Request (ARQ) for requesting retransmission of erroneously received baseband packet, and Forward Error Correction (FEC) for correcting bit-errors.

The Logical Link Control and Adaptation Protocol (L2CAP) layer 140 is responsible for protocol multiplexing of the upper layers such as RFCOMM and SDP layers, segmentation of the upper layer data units appropriated for the baseband packet and reassembly of the baseband packets into the upper layer packet, and Quality of Service (QoS).

The Radio Frequency Communication Protocol (RFCOMM) layer 150 emulates the 9-pin serial port of the RS-232 based on the TS 07.10 of the European Telecommunications Standards Institute (ETSI), and the Service Discovery Protocol (SDP) 150 enables applications to discover which services and service characteristics are available on other Bluetooth devices.

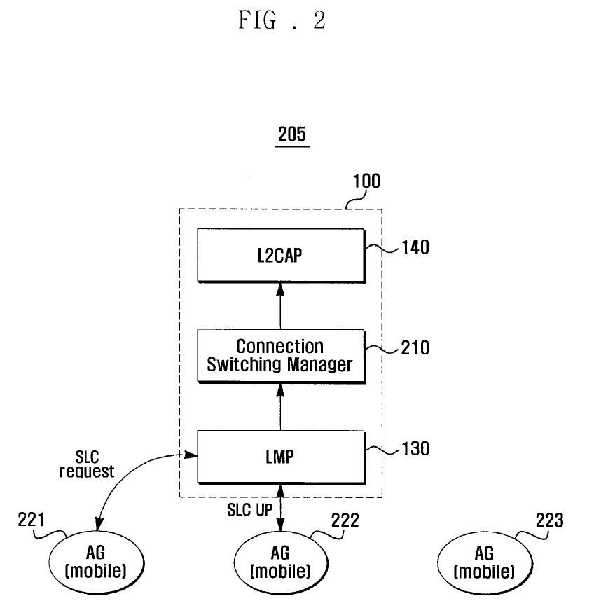

FIG. 2 is a diagram illustrating an overview of a multi-device audio connection system according to an exemplary embodiment of the present invention. In the exemplary embodiment of FIG. 2, the piconet 205 preferably includes a headset operating as a master device 100 and multiple mobile terminals 221, 222, and 223 operating as slave devices. However, the presently claimed invention is not limited to the configuration of the piconet of FIG. 2. For instance, the audio connection switching system of the present invention can be applied to the piconet configured with a mobile terminal as a master device and multiple headsets as slave devices. In FIG. 2, the mobile terminal may comprise any of the various types of terminals equipped with a Bluetooth module supporting audio data services or a Host Controller Interface (HCI) for coupling with a Bluetooth device. Although the master device 100 is depicted only including the L2CAP entity 140 and the LMP entity 130 sandwiching a newly introduced Connection Switching Manager (CSM) 210 in FIG. 2, the master device 100 includes other protocol layer entities arranged as shown in FIG. 1.

Prior to describing the exemplary embodiment of FIG. 2, a general procedure for forming a piconet shall be described first. Devices not connected in a piconet are in standby mode. In this particular mode, the Bluetooth devices currently listen for messages every 1.28 seconds. If a device seeks to make a connection with another device, the device seeking to make a connection sends out a page message if the address of the other device is known, or an inquiry followed by a page message if the address is unknown. The device that initiated the connection is designated as the master device. At this time, the devices that received an 8-bit park address are in park mode. The slave devices in connection with the master device are assigned 3-bit (2³=8) active addresses to form a piconet. Address 0 is reserved for a broadcast, and there can be up to 7 slave devices in active mode. The slave devices can be in one of four operation modes: active mode in which data transmission occurs, hold mode in which the ACL traffic is suspended, sniff mode in which the master can only start transmission in specific time slots, and park mode in which the device listens to the traffic of the master to re-synchronize and check on broadcast messages. The slave device in sniff mode preferably stays synchronized in the piconet but the duty cycle of the slave's listen activity is reduced such that the master can only start transmission in specified time slots. In the following description, it is assumed that the master and slave devices are connected as SCO links or ACL links.

Referring now to FIG. 2, the master device 100 includes the Connection Switching Manager (CSM) entity 210 as an upper layer entity of the Link Manager Protocol (LMP) entity 130 and as a lower layer entity of the L2CAP entity 140. Although not shown in FIG. 2, the master device 100 can further include, for example, at least one of an RF layer entity, a baseband layer entity, an RFCOMM entity, an SDP entity, and an application entity. Since there is a maximum of three SCO links available in a piconet, the master device 100 can maintain a list of three slave devices. Here, it is assumed that the slave device list is acquired and saved during the inquiry process for forming the piconet. Also, it is assumed that the three slave devices support the same Bluetooth profile, e.g. Bluetooth devices supporting the headset profile. Here, each slave device can be a mobile terminal, a Personal Computer (PC), and their equivalents supporting the headset profile and acting as an Audio Gateway (AG). AG is the gateway of the audio both for input and output.

When the master device 100 is in the process of providing an audio data service with the slave device 222 through a SCO link, another slave device 221 (or 223) may request for an audio data service connection to the master device 100. If an audio data service request is received from the slave device 221 while the master device 100 is still in the process of providing the audio data service with another slave device 222, the LMP entity 130 of the master device 100 transfers the audio data service request to the CSM entity 210. Upon receipt of the audio data service request, the CSM entity 210 determines whether the audio data service requested by the slave device 221 is accepted. Whether the requested audio data service is accepted or denied depends on the configuration set for the link control. The link control configuration can be set for connecting/disconnection link with the AGs by the user. The link control configuration can be preset as a voice recognition mode or a user favorite mode. For example, the link control configuration may comprise information about which device is allowed to request the audio data service. The link control configuration may comprise a list of identifiers of allowed devices to request for audio data service to the master device 100.

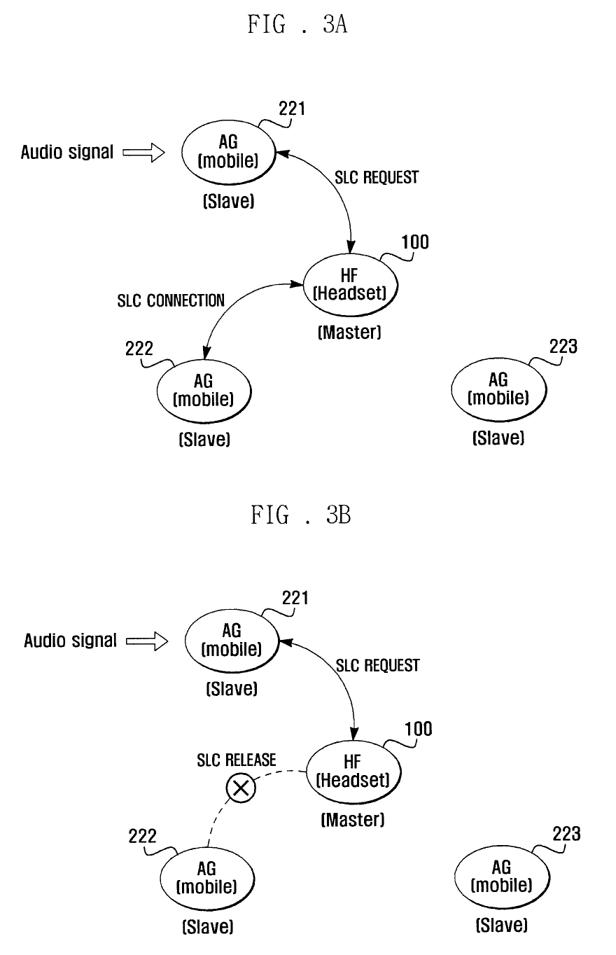

In case that the link control configuration is set to the voice recognition mode, if a voice communication service is requested by the AG 221, while the master device is in the middle of another voice communication service with the AG 222, the CSM 210 holds the SCO link with the AG 222 and connects another SCO link with the AG 221. As a consequence, the master device 100 performs the voice communication service with the AG 221. If the audio packets are received from the AG 221 through the new SCO link, the L2CAP entity 140 reassembles the audio packets into upper layer data unit and then delivers the reassembled upper layer data unit to the upper layer. In this manner, the master device 100 establishes the SCO link with the AG 221 for the audio data service while maintaining the other SCO link with the AG 222. The SCO link switching procedure is described hereinafter in more detail with reference to FIGS. 3A and 3B.

FIGS. 3A and 3B are diagrams illustrating an example of an audio connection switching procedure in a multi-device audio connection system of FIG. 2.

Now referring to FIGS. 3A and 3B, it is assumed that a headset 100 as the master device is in the middle of the audio data service, such as voice communication service, with an AG 222 as a slave device. If a voice signal is input, the AG 221 requests the HF 100 for an SCO link and SLC. At this time, the AG 221 is one of the devices contained in the list of the HF 100. Upon receipt of the SCO link establishment request, the CSM entity 210 (see FIG. 2) of the HF 100 holds the SCO link with the AG 221 and determines whether the SCO link establishment request is accepted. If it is determined that the SCO link establishment request is accepted, the CSM entity 210 alerts of the potential suspension of the SCO link with the AG 222 and attempts establishment of another SCO link with the AG 221. Once the SCO link with the AG 221 is established successfully, the HF 100 performs the audio data service with the AG 221. It is noted that the HF 100 maintains the SCO link with the AG 222 while another SCO link is being established with the AG 221.

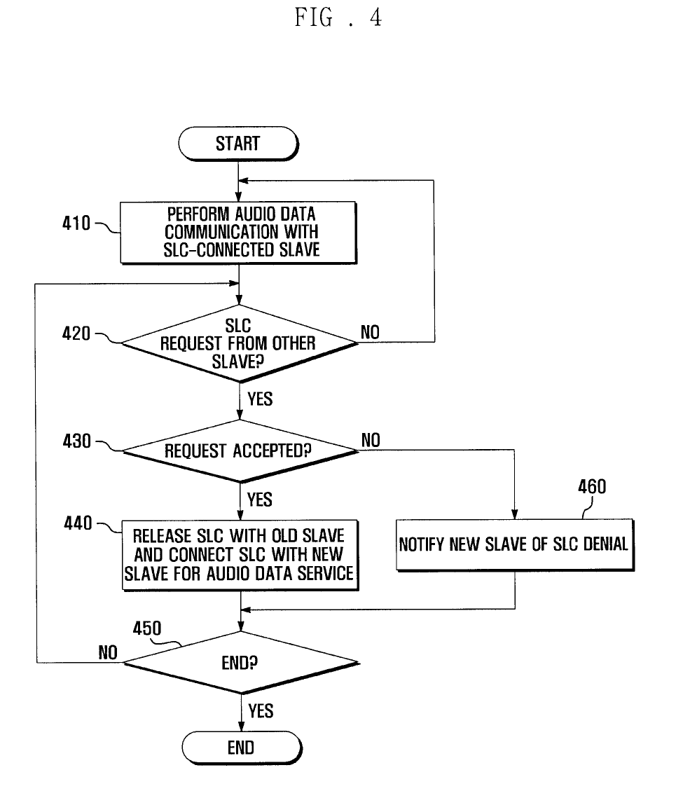

FIG. 4 is a flowchart illustrating an operational example of an audio data service provision method according to an exemplary embodiment of the present invention.

Referring now to FIG. 4, the Master device 100 of FIG. 2 performs an audio data communication with a first slave device through an SCO link and SLC established therebetween (410). The SCO link is established such that the master device discovers a slave device through the inquiry and paging process. As aforementioned, the Master device 100 can store up to three Bluetooth devices in a list for the SCO link. At this time, the three Bluetooth devices in the list support the same profile. While performing the audio data communication, the Master device 100, particularly the CSM 210 of the Bluetooth device, monitors to detect an SCO link and SLC establishment request, i.e. SLC request transmitted by a second slave device (420).

If an SLC request is received from a second slave device, the master device 100, particularly the CSM 210 of the master device 100, determines whether the second slave device exists in the neighbor device list and the SLC request is accepted (430). If the second slave device exists in the neighbor device list and the SLC request is accepted, the CSM 210 of the master device 100 releases the SCO link to the first slave device and establishes a SCO link with the second slave device to perform audio data communication with the second slave device (440). Before releasing the SCO link to the first slave device, the master device 100 preferably can alert the release of the SCO link to the first slave device. In this case, the first slave device received the SCO link release alert preferably outputs a notification message and replies to the master device according to the user decision. While performing the audio data communication with the second slave device, the master device 100 monitors, inter alia, in order to detect a termination request (450). If a termination request is detected, the master device 100 ends the audio data communication session. Otherwise, in the case where there is no termination request detected, the procedure goes back to step 420. If the second slave device does not exist in the neighbor device list or the SLC request is not accepted at step 430, the CSM 210 of the master device 100 notifies the second slave device that the SLC request is denied (460). In this case, the CSM 210 of the master device 100 maintains the SCO link to the first slave device for maintaining the audio data communication.

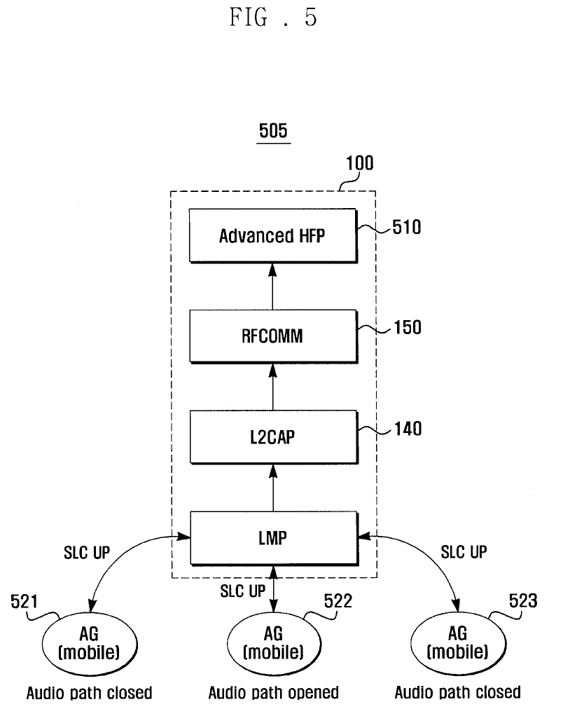

FIG. 5 is a diagram illustrating a multi-device audio connection system according to another exemplary embodiment of the present invention. In the exemplary embodiment shown in FIG. 5, a piconet 505 includes a headset operating as a master device and multiple mobile terminals operating as slave devices. However, a person of ordinary skill in the art understands and appreciates that the present invention is not limited in any way to the exemplary configuration of the piconet 505 of FIG. 5. For an example of one possible variation, the audio connection switching system of the present invention is also applicable to piconets configured such that a mobile terminal is a master device and multiple headsets are slave devices. In FIG. 5, the mobile terminal comprises any of the various types of devices equipped with a Bluetooth module supporting audio data services, or a Host Controller Interface (HCI) for coupling with a Bluetooth device.

Although the master device 100 in FIG. 5 is depicted with only the LMP entity 130, the L2CAP entity 140, and RFCOMM entity 130 along with a newly introduced Advanced HFP (AHFP) entity 510, the master device 100 can further include, for example, other protocol layer entities arranged as shown in FIGS. 1 and/or 2.

Referring now to FIG. 5, the master device 100 includes an AHFP entity 510 as an upper layer entity of the RFCOMM entity 150. Since there is a maximum of three SCO links available in a piconet, the master device 100 establishes SCO links with three Bluetooth devices, i.e. slave devices 521, 522, and 523 discovered through the inquiry and page process for audio data services. Also, the master device 100 establishes Asynchronous Connectionless links (ACL) with the three slave devices 521, 522, 523 for packet data services in addition to the SCO links. In FIG. 5, when an audio path between the master device 100 and the second slave device 522 is opened for voice communication service, the ACL links between the master device 100 and the first and third slave devices 521 and 523 can be maintained, whereby the master device 100 maintains the connections to the three slave devices. Here, the audio path is a logical channel is differentiated from the SCO link and the audio data channel. Although not depicted in FIG. 5, the master device 100 and the first to third slave devices 521, 522, and 523 are connected through respective ACL links.

The master device (HF) 100 is connected to the first to third slaves (AGs) 521, 522, and 523 in this example through the SCO links.

In this situation, the AHFP entity 510 of the master device 100 assigns an audio path to the second slave device 522 such that the master device 100 performs the audio data service with the second slave device 522. The AHFP entity 510 of the master device 100 detects an audio path request transmitted by a slave device and determines whether the audio path request is accepted. If the audio path request is accepted, the master device 100 closes the current audio path and opens a new audio path to the slave device transmitted the audio path request. In FIG. 5, the master device 100 performs the audio data service with the second slave device 522 through the opened audio path and the packet data services with the first and third slave devices 521 and 523 through the ACL links.

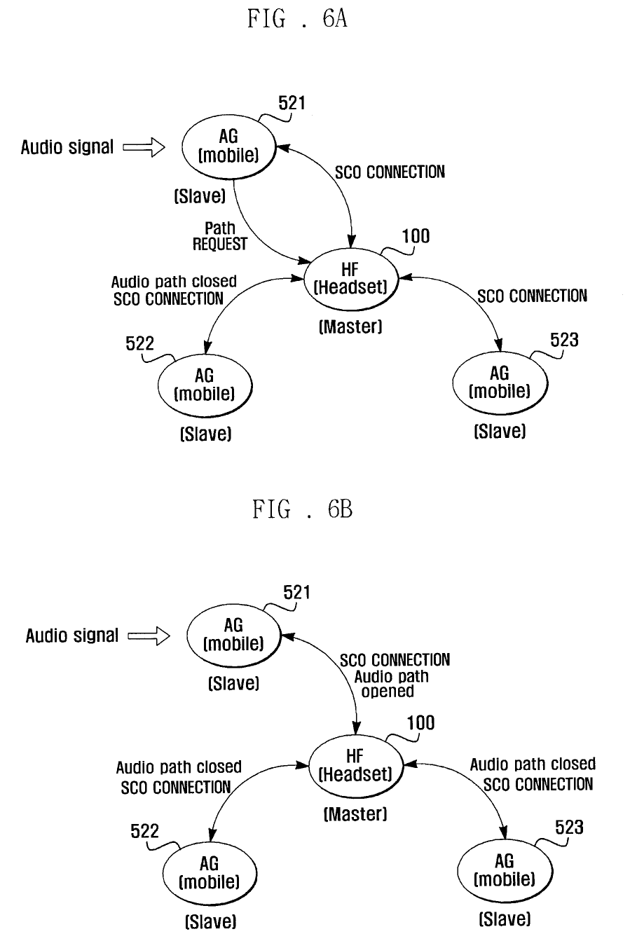

FIGS. 6A and 6B are diagrams illustrating an audio connection switching procedure in the multi-device audio connection system of FIG. 5.

In FIGS. 6A and 6B, the master device 100 is connected to the first through third slave devices 521, 522, and 523 via the respective SCO links, and an audio path is assigned (opened) between the master device 100 and the second slave device 522 under the control of the AHFP 510 of the master device. This arrangement means that the master device 100 is in the process of providing the audio data service with the second slave 522. Typically, the SCO link is used for transmitting voice packets that are delay-sensitive and does not require transmission reliability. Whereas, the ACL link is used for transmitting data packets that require transmission reliability but is not delay-sensitive. If an audio signal is input in the first slave device 521 while the master device 100 is in the middle of the audio data service with the second slave device 522, the first slave device 521 requests the master device 100 for allocation of an audio path. Upon receipt of the audio path request from the first slave device 521, the AHFP entity 510 of the master device 100 verifies the audio path request of the first slave device 521 and assigns, if the request is accepted, an audio path to the first slave device 521. The acceptability verification is made according to a preset mode or by asking the user to decide whether or not to accept the request. For instance, when a user voice is input such at the voice signal is generated at the first slave device 521 while the audio path is opened between the master device 100 and the second slave device 522, the master device 100 can switch the audio path assigned for the second slave device 522 to the first slave device 521, thereby performing audio communication with the first slave device 521.

The AHFP entity 510 of the master device 100 determines whether to switch the audio path from the second slave device 522 to the first slave device 521 when received the audio path request from the first slave device 521 as shown in FIG. 6A and, if the audio path request is accepted, closes the audio path to the second slave device 522 and opens a new audio path to the first slave device 521 as shown in FIG. 6B. Although the audio path to the second slave device 522 is closed, the second slave device 522 may maintains an ACL link with the master device 100 for a packet data service. When it is determined to close the audio path to the second slave device 522, the master device 100 may alert the second slave device 522 about the closure of the audio path. Upon receipt of the alert, the second slave device 522 may request the user to permit the close of the audio path, whereby the audio path to the second slave device 522 is closed depending on the user's decision. Afterward, the audio path can be switched backed to the second slave device 522 under the control of the AHFP entity 510 of the master device 100 in accordance with the audio path request of the second slave device 522 and the user's decision. In this manner, the master device can perform the audio data service with multiple slave devices by quickly switching the audio path between at least two slave devices. In an exemplary case of a headset connected to multiple terminals for voice communications, the headset can be configured such that the audio path is quickly switched to the terminal to which a voice signal is input among the terminals.

The aforementioned description has provided examples of audio data service provision methods according to an exemplary embodiment in which a master device operating with a protocol stack having a CSM 210 (see FIG. 2) switches the audio data service among multiple slave devices connected to the master device through respective SCO links by assigning SLC in response to the SLC request as shown in FIGS. 3A and 3B, and another exemplary embodiment in which a master device operating with a protocol stack having an AHFP 510 (see FIG. 5) switches the audio data service among three slave devices connected to the master device through respective SCO links and ACL links by assigning the audio path in response to the audio path request from individual slave devices under the control of the AHFP 510 as shown in FIGS. 6A and 6B. However, the present invention is not limited thereto. For example, the audio path described with reference to FIGS. 6A and 6B can be assigned and withdrawn (i.e. opened/closed) under the control of a CSM entity implemented in the protocol stack of the master device, and the SCL described with reference to FIGS. 3A and 3B can be assigned and withdrawn under the control of an AHFP entity implemented in the protocol stack of the master device.

As described above, the audio data service provision method and system of the present invention is advantageous to facilitate switching audio data service between a master device and multiple slave devices.

Also, the audio data service provision method and system of the present invention allows a master device to switch the audio data service among the slave devices operating as Audio Gateways according to a switching mode set by the user, thereby providing quick and user-friendly multi-device audio connection service.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims. For example, the inventive method and system is not limited to Bluetooth, and is applicable to other wireless communication protocols.

What is claimed is:

1. An audio data service provision method comprising:
establishing a first audio data channel between a first device and a second device for providing an audio data service;
receiving, at the first device, an audio data channel assignment request from a third device; and
releasing, by the first device, when the audio data channel assignment request is accepted, the first audio data channel and establishing a second audio data channel with the third device for providing the audio data service.

2. The audio service provision method of claim 1, wherein the first device, second device and third device comprise a first Bluetooth device, a second Bluetooth device, and a third Bluetooth device, respectively.

3. The audio data service provision method of claim 2, wherein the first Bluetooth device comprises one of a handsfree or a headset, and the second Bluetooth device and third Bluetooth device comprise mobile terminals.

4. The audio data service provision method of claim 2, wherein the first Bluetooth device comprises a mobile terminal, and each of the second Bluetooth device and third Bluetooth devices comprises one of a handsfree or a headset.

5. The audio data service provision method of claim 2, further comprising activating headset profiles of the first Bluetooth device, second Bluetooth device, and third Bluetooth device.

6. The audio data service provision method of claim 5, further comprising activating a Connection Switching Manager (CSM) protocol on a Link Manager Protocol (LMP) of the first Bluetooth device, the CSM protocol for controlling switching the audio data service between the first audio data channel and a second audio data channel.

7. An audio data service provision method comprising:
assigning, at a first device, audio data channels and packet data channels to a second device, and a third device, individually;
opening an audio path to the second device for an audio data service;
receiving by the first device, an audio path request from the third device; and
closing by the first device, when the audio path request is accepted, the audio path to the second device and opening the audio path to the third device.

8. The audio data service provision method of claim 7, wherein the first device assigns an audio data channel and a packet channel individually to a fourth device, and wherein the first device, second device, third device and fourth device comprise a first Bluetooth device, a second Bluetooth device, a third Bluetooth device, and fourth Bluetooth device, respectively.

9. The audio data service provision method of claim 8, wherein the first Bluetooth device comprises one of a handsfree or a headset, and the second Bluetooth device, third Bluetooth device, and fourth Bluetooth device comprise mobile terminals.

10. The audio data service provision method of claim 8, wherein the first Bluetooth comprises a mobile terminal, and each of the second Bluetooth device, third Bluetooth device, and fourth Bluetooth device comprises one of a handsfree or a headset.

11. The audio data service provision method of claim 8, further comprising performing packet data services with the third Bluetooth device and fourth Bluetooth device through the packet data channels while performing the audio data service with the second Bluetooth device.

12. The audio data service provision method of claim 8, further comprising activating headset profiles of the first to fourth Bluetooth devices.

13. The audio data service provision method of claim 12, further comprising activating an Advanced Handsfree Profile (AHFP) on an upper layer of the first Bluetooth device for controlling logical channel switching among the second Bluetooth device, third Bluetooth device, and fourth Bluetooth device.

14. An audio data service provision system comprising:
a master device which performs an audio data service with a device connected through an opened audio data channel, verifies, when an audio data channel assignment request is received, the audio data channel assignment request and controls assignment of the audio data channel; and
at least one slave device which sends the audio data channel assignment request to the master device when audio data to be transmitted to the master device is generated.

15. The audio data service provision system of claim 14, wherein the master device comprises a master Bluetooth device and said at least one slave device comprises at least one slave Bluetooth device.

16. The audio data service provision system of claim 15, wherein the master Bluetooth device comprises one of a handsfree or a headset, and said at least one slave Bluetooth device comprises mobile a terminal.

17. The audio data service provision system of claim 15, wherein the master Bluetooth device comprises a mobile terminal, and said at least one slave Bluetooth device comprises one of a handsfree or a headset.

18. The audio data service provision system of claim 15, wherein each of the master Bluetooth device and said at least one slave Bluetooth device comprises a headset profile.

19. The audio data service provision system of claim 18, wherein the master Bluetooth device includes a Radio Frequency (RF) entity, a Baseband entity, a Link Manage Protocol (LMP) entity, a Logical Link Control and Adaptation Protocol (L2CAP) entity, a Radio Frequency Communication Protocol (RFCOMM) entity, and an application entity.

20. The audio data service provision system of claim 19, wherein the master Bluetooth device further includes a Connection Switching Manager (CSM) entity on a Link Manager Protocol (LMP) entity.

21. The audio data service provision system of claim 15, wherein the master Bluetooth device assigns an audio data channel and a packet data channel to said at least one slave Bluetooth device and opens an audio path to said at least one slave Bluetooth device.

22. The audio data service provision system of claim 21, wherein said at least one slave Bluetooth device comprises a first one of two or more slave Bluetooth devices, and wherein the master Bluetooth device verifies, when an audio path request is received from a second slave Bluetooth device, the audio path request and closes, when the audio path request is accepted, the audio path to the first slave Bluetooth devices and opens the audio path to the second slave Bluetooth device transmitted the audio path request.

23. The audio data service provision system of claim 22, wherein the master Bluetooth device comprises a headset profile and an Advanced Handsfree Profile (AHFP) for controlling logical channel switching among slave devices.
